(19) United States
(12) Patent Application Publication
(10) Pub. No.: US 2016/0367989 A1
(43) Pub. Date: Dec. 22, 2016

(54) MICROFLUIDIC DEVICE FOR HANDLING IMMISCIBLE FLUIDS

(71) Applicant: ESPCI PARISTECH, Paris (FR)

(72) Inventors: AXEL HUERRE, PARIS (FR); VINCENT MIRALLES, PARIS (FR); MARIE-CAROLINE JULLIEN, PARIS (FR); BASTIENÈ FOURNIE, PAMIERS (FR); HANNAH WILLIAMS, LONDON (GB); BERTRAND SELVA, BEAUVILLE (FR)

(21) Appl. No.: 15/108,281

(22) PCT Filed: Dec. 24, 2014
(86) PCT No.: PCT/EP2014/079337

§ 371 Date: Jul. 17, 2016

(30) Foreign Application Priority Data
Dec. 24, 2013 (FR) 1363551

(51) Int. Cl. B01L 3/00; F04B 43/04; F16K 99/00

(52) U.S. Cl. CPC B01L 3/502784; F16K 99/0026; F16K 99/0044; F04B 43/043; B01L 2300/123; B01L 2200/0673; B01L 2400/0481; B01L 2200/14; B01L 2300/1805; B01L 2300/087; F16K 2099/0084

(57) ABSTRACT

A process for handling an element consisting of a first fluid transported by a second fluid that is immiscible with the first fluid in a cavity having at least one wall of which is made of a deformable material. The second fluid and the element of the first fluid are introduced into the cavity. A local deformation of the deformable material of the cavity is ordered and at least one other portion of the deformable material of the cavity not being deformed. A portion of the deformable material forming the cavity is locally deformed to at least partially obstruct the passage of the element introduced into the cavity without obstructing the passage of the second fluid. The element in the cavity is moved to the outside of the deformed portion of the cavity.

### TECHNICAL FIELD OF THE INVENTION

The present invention relates to a handling device, a generating device, a sorting device, a storage device for an element consisting of a first fluid transported in a second fluid that is immiscible with the first fluid, and a device for combining two elements consisting of first miscible fluids transported in a second fluid immiscible with each first fluid. It applies, in particular, to biological diagnosis and to chemical and biochemical analyses. The invention relates to two main configurations, either the element of the first fluid is transported by a flow of the second fluid, or the flow of the second fluid is zero.

### STATE OF THE ART

The term “element of a fluid” refers, for example, to a drop of a liquid or an air-bubble.

In current biological diagnosis systems based on small-volume liquid samples using, for example, digital microfluidic systems based on handling bubbles/drops of a first fluid in a second fluid, optimum handling of the amount of sample available is a major constraint. The most advanced systems today are based on optimally controlling the flow of an element of the sample.

In these types of systems, the functions to be performed in particular, in the case of systems with a flow of the second fluid, are:
generating an element;
moving an element;
isolating an element;
splitting an element;
sorting an element;
storing an element;
forcing contact between two elements;
combining elements; and
retaining an element in the manner of a valve.

The functions to be performed in particular, in the case of systems with no flow of the second fluid, are:
moving an element;
isolating an element;
splitting an element;
sorting an element;
storing an element;
forcing contact between two elements; and
combining elements.

However, there is currently no system that enables all these functions to be performed optimally independent of the presence of a flow of the second fluid.

In “EWOD” (“Electrowetting On Dielectrics”) type systems, the element handling functions can be performed. These systems consist of modifying the wetting properties of a functionalized substrate, by applying an electrical field, allowing the handling, generating, sorting, combining and storing functions described above to be performed.

However, these systems have the drawback of having a triple line at the location of the element. This element being in direct contact with the substrate, ie without lubrication of the substrate, this makes handling the element difficult. In addition, these systems require high electric potential to work, of the order of 100 Volts, which makes these systems suboptimum in terms of energy. To overcome this energy constraint, the thickness of the layer of the dielectric material can be reduced, which makes the manufacture of these systems complex in this case.

Other systems use dielectrophoresis, ie the application of an electromagnetic field to handle an element. These systems only make it possible to perform a sorting function with a flow or an isolation function with no flow.

In particular, systems are known that implement the instruction of patent application WO 2008/150210. In such systems, a micro-pump is produced by utilizing two diaphragms activated by phase-change actuators. These systems have, in particular, integration difficulties.

For all these reasons, current systems do not make it possible to provide an optimum response to the requirements for:
energy optimization;
ease of manufacture;
absence of a triple line likely to contaminate a sample or the substrate; and
performing all the handling functions desired.

### SUBJECT OF THE INVENTION

The present invention aims to remedy all or part of these drawbacks.

To this end, according to a first aspect the present invention envisages an element handling process consisting of a first fluid transported by a second fluid, immiscible with the first fluid, in a cavity, at least one wall of which is made of a deformable material, which comprises:
a step of introducing the second fluid and the element of the first fluid into the cavity;
a step of ordering a local deformation of a portion of the deformable material of the cavity, at least one other portion of the deformable material of the cavity not being deformed;
a step of locally deforming a portion of the deformable material of the cavity to at least partially obstruct the passage of the element introduced into the cavity without obstructing the passage of the second fluid; and
a step of moving the element in the cavity to the outside of the deformed portion of the cavity.

Thanks to these provisions, it is possible to move an element or handle this element by exerting physical pressure on the element so as to force its movement. In addition, the presence of the second fluid, wetting the wall of the cavity, makes it possible to prevent the element coming into contact with the wall, limiting the risk of elements being contaminated.

In some embodiments, the process that is the subject of the present invention comprises a step of determining the position of an element of the cavity according to the position of a deformed portion of the cavity.

These embodiments make it possible to predict the position of the element in the cavity, this position information being able to be used for ordering a deformation of another portion, made of a deformable material, of the cavity.

In some embodiments, the process that is the subject of the present invention comprises a step of detecting the position of an element in the cavity, the ordering step ordering the deformation of a portion of the deformable material of the cavity selected according to the detected position of the element.

These embodiments make it possible to use this position information to order a deformation of another portion, made of a deformable material, of the cavity.

In some embodiments, the deformation of a portion of the deformable material is performed by locally heating the deformable material, the deformed portion of the deformable material being deformed by thermomechanical effect.

In some embodiments, the deformation of a portion of the deformable material is performed by a pneumatic deformation means.

In some embodiments, the deformation of a portion of the deformable material is performed by a piezoelectric deformation means.

The present invention envisages, according to a second aspect, a device for handling an element consisting of a first fluid transported in a second fluid that is immiscible with the first fluid, which comprises:
a cavity, configured to receive at least one element consisting of the first fluid and the second fluid, which comprises at least one wall made of a material deformable by thermomechanical effect;
at least one local heating means configured to deform at least one portion of the deformable material of the cavity by thermomechanical effect such that, when the local heating means heats, each portion of the deformable material heated obstructs at least partially a section of the cavity to allow the passage of the second fluid and to block the passage of each element of the first fluid, at least one other portion of the deformable material of the cavity not being deformed;
a means for moving the element consisting of the first fluid, configured to move the element to the outside of the deformed portion of the deformable material; and
an ordering means configured to separately order the heating of at least one local heating means.

Thanks to these provisions, it is possible to move an element by using physical pressure on the element so as to force its movement. The electrical voltage necessary to perform the deformation is low compared to the voltages applied, for example, with EWOD. In addition, the presence of the second fluid, wetting the wall of the cavity, makes it possible to prevent the element coming into contact with the wall, limiting the risk of elements being contaminated.

In some embodiments, the heat transfers are very rapid, of the order of some hundred milliseconds, which ensures almost instantaneous heating of the deformable material heated by a local heating means.

In some embodiments, the moving means is a thermal rail, comprising at least one local heating means configured to deform at least one portion of the deformable material of the cavity by thermomechanical effect such that, when the local heating means heats, each portion made of a deformable material heated obstructs at least partially a section of the cavity to allow the passage of the second fluid and to block the passage of each element of the first fluid.

These embodiments have the advantage of allowing, in the case of a local heating zone that is small in relation to the length of the cavity, local handling of at least one element according to the handling to be performed.

In some embodiments, the ordering means is configured to order the successive heating of local heating means of the thermal rail so as to move the element along the cavity.

These embodiments have the advantage of allowing an element to be moved in the cavity without requiring an exterior flow. In addition, it is possible to force two elements to come into contact by pushing each element towards the other.

In some embodiments, the cavity comprises at least one side portion made of a material that cannot be deformed by the heat emitted by at least one local heating means.

These embodiments have the advantage of making it easier to manufacture the device that is the subject of the present invention.

In some embodiments, the moving means comprises a means for generating a flow of the second fluid for moving at least one element.

These embodiments have the advantage of allowing a capillary valve function to be performed by blocking one element moved by a flow.

In some embodiments, the device that is the subject of the present invention comprises a means for detecting the content of an element of the first fluid.

The advantage of these embodiments is that they make it possible, depending on the content detected, to perform an operation on the element such as moving or, conversely, isolating the element, for example.

In some embodiments, the device that is the subject of the present invention comprises a means for detecting the position of at least one element in the cavity, to supply a position signal to the ordering means.

These embodiments have the advantage of allowing the operation performed on the element to be optimized according to the detected position of the element.

In some embodiments:
the cavity comprises at least one translucent portion;
the means for detecting the position of at least one element in the cavity comprises an image capture means and a means for processing captured images configured to determine the position of an element according to the image processed.

The advantage of these embodiments is that they make it possible, with a single detection means, to detect a plurality of elements in the case of a complex device comprising a plurality of cavities and/or of devices that are the subjects of the present invention.

In some embodiments, the detection means is configured to detect an element of the first fluid according to a disturbance in an electromagnetic field near the cavity.

These embodiments have the advantage of allowing the position of an element to be detected without constraints of brightness, for example.

In some embodiments, the ordering means is configured to cause the heating of at least two adjacent portions of the deformable material at the detected position of the element so as to isolate the element in a portion of the cavity obstructed at each end by a deformation of the cavity.

The advantage of these embodiments is that they make it possible to retain an element in a duct narrowed at each end by a deformation of the cavity.

In some embodiments, the ordering means is configured to order the heating of a portion of the deformable material of the cavity at the detected position of the element to split said element into two elements positioned towards the outside of the heated portion of the deformable material.

These embodiments have the advantage of enabling the optimum splitting of an element whose dimensions are large in relation to the dimension of the deformed portion of the deformable element by the heat emitted by a local heating means.

In some embodiments, the device that is the subject of the present invention comprises a substrate, comprising at least one local heating means, secured to the cavity.

The advantage of these embodiments is that they make it possible to retrieve each local heating means in the substrate by detaching the substrate from the cavity.

According to a third aspect, the present invention envisages a device for generating elements, consisting of a first fluid transported in a second fluid that is immiscible with the first fluid, which comprises a device for handling a subject of the present invention, in which:
an opening of the cavity towards at least one secondary cavity is crossed by at least one continuous phase flow;
the moving means is configured to move a flow of the first fluid in the cavity towards the secondary cavity to form an element of the first fluid in the secondary cavity; and
a local heating means heating the deformable material positioned at the intersection of the two cavities such that, during the heating of the portion of the deformable material, the passage of elements from the cavity to the secondary cavity is blocked or forced.

Thanks to these provisions, it is possible to control the size of an element generated in the secondary cavity by splitting this element through deformation of the cavity at the location of the intersection.

Without the action of a local heating means, an element can form naturally but its size is then determined by the ratios of the flow rates and by the geometry of the junction between the two cavities. Thanks to the generating device that is the subject of the present invention, it is possible to control the size of the elements generated.

According to a fourth aspect, the present invention envisages a device for sorting at least one element consisting of a first fluid transported in a second fluid that is immiscible with the first fluid, which comprises:
a means for activating an ordering means of a device for handling an element that is the subject of the present invention;
the device for handling an element, which comprises:
   at least two openings of the cavity located downstream of a direction of movement of the moving means, each giving onto a secondary cavity; and
   a local heating means heating the deformable material positioned at each intersection so as to block the passage of an element from the cavity to at least one secondary cavity.

Thanks to these provisions, it is possible to sort elements of different natures so as, in particular, to separate these elements.

According to a fifth aspect, the present invention envisages a device for storing/restituting an element consisting of a first fluid transported in a second fluid that is immiscible with the first fluid, which comprises:
a handling device that is the subject of the present invention, in which one portion of the deformable material is configured, during the deformation, to block the passage of an element in a primary cavity and direct this element towards a storage/restitution structure; and
the storage/restitution structure configured such that, during the heating of a portion of the deformable material of the structure, by a local heating means of the secondary device, the element is restituted.

Thanks to these provisions, it is possible to store an element present in the first cavity. In addition, these provisions allow a sequence of elements of the first fluid to be reorganized.

In some embodiments, the device that is the subject of the present invention comprises a portion made of a deformable material located at the junction between the primary cavity and the storage/restitution structure.

These embodiments make it possible to isolate a stored element.

In some embodiments, the portion of the deformable material located at the junction between the primary cavity and the storage/restitution structure is configured to be heated when an element is stored in the structure.

These embodiments have the advantage of allowing the isolation of a stored element to be automated.

In some embodiments, the storage/restitution structure comprises a duct configured to supply the primary cavity with the second fluid contained in the structure.

These embodiments allow an element to be stored in the storage structure more easily when the primary cavity is blocked.

According to a sixth aspect, the present invention envisages a device for combining two elements consisting of first miscible fluids transported in a second fluid immiscible with each first fluid, which comprises a handling device that is a subject of the present invention, comprising a plurality of deformed portions configured to force the two elements into contact by successively moving at least one of the two elements.

Thanks to these provisions, it is possible to force contact between two elements consisting of different fluids.

According to a seventh aspect, the present invention envisages a matrix device for handling an element consisting of a first fluid transported in a second fluid that is immiscible with the first fluid, which comprises a device for handling an element consisting of a first fluid transported in a second fluid that is immiscible with the first fluid, the subject of the present invention, in which the cavity extends in two directions and which comprises:
at least one compartment comprising at least three outlets; and
at least one heating means making it possible to deform a portion of the deformable material positioned opposite at least one outlet.

These embodiments have the advantage of allowing a matrix movement to be performed if the cavity comprises a plurality of compartments. The following 3 cases can be envisaged: the entire matrix is subjected to a flow; no flow crosses the matrix; and a flow crosses only one portion of the matrix. In this matrixing, all the functions proposed above can be performed. In some variants, these functions are assisted by a detection and/or identification system. To achieve this matrixing, it is just necessary to produce a network of local heating means having an angle. In this geometry the device makes it possible to perform an obstacle bypass function. In this geometry, the device makes it possible to perform a reorganization of sequences of elements of first fluids, or other functions described below.

### BRIEF DESCRIPTION OF THE FIGURES

Other advantages, aims and particular features of the invention will become apparent from the non-limiting description that follows of at least one particular embodiment of the process and the devices that are the subjects of the present invention, with reference to drawings included in an appendix, wherein:

FIG. 1 represents, schematically, a cross-section view of a particular embodiment of the device for handling an element that is the subject of the present invention;

FIG. 2 represents, schematically, a particular embodiment of the device for handling an element that is the subject of the present invention;

FIG. 3 represents, schematically, a cross-section view of a particular embodiment of a movement of an element by the device that is the subject of the present invention;

FIG. 4 represents, schematically, a cross-section view of a particular embodiment of an isolation of an element by the device that is the subject of the present invention;

FIG. 5 represents, schematically, a cross-section view of a particular embodiment of a capillary valve by the device that is the subject of the present invention;

FIG. 6 represents, schematically, a top view of a particular embodiment of the device for generating an element that is the subject of the present invention;

FIG. 7 represents, schematically, a top view of a particular embodiment of the device for sorting an element that is the subject of the present invention;

FIG. 8 represents, schematically, a top view of a particular embodiment of the storage/restitution device that is the subject of the present invention;

FIG. 9 represents, schematically, a top view of a particular embodiment of the device that is the subject of the present invention, wherein the cavity extends in two directions;

FIG. 10 represents, schematically, a particular embodiment of a network for handling an element that is the subject of the present invention;

FIG. 11 represents, schematically, a cross-section view of a particular embodiment of the device for handling an element that is the subject of the present invention;

FIG. 12 represents, schematically, a logical diagram of particular steps of the process that is the subject of the present invention; and

FIG. 13 represents, schematically, a cross-section view of the cavity that is the subject of the present invention.

### DESCRIPTION OF EXAMPLES OF REALIZATION OF THE INVENTION

The present description is given as a non-limiting example.

It is now noted that the figures are not to scale.

In the rest of the description, the term “element of a fluid” refers, for example, to a drop of a liquid, an air-bubble. However, the present invention is not restricted to only these two cases.

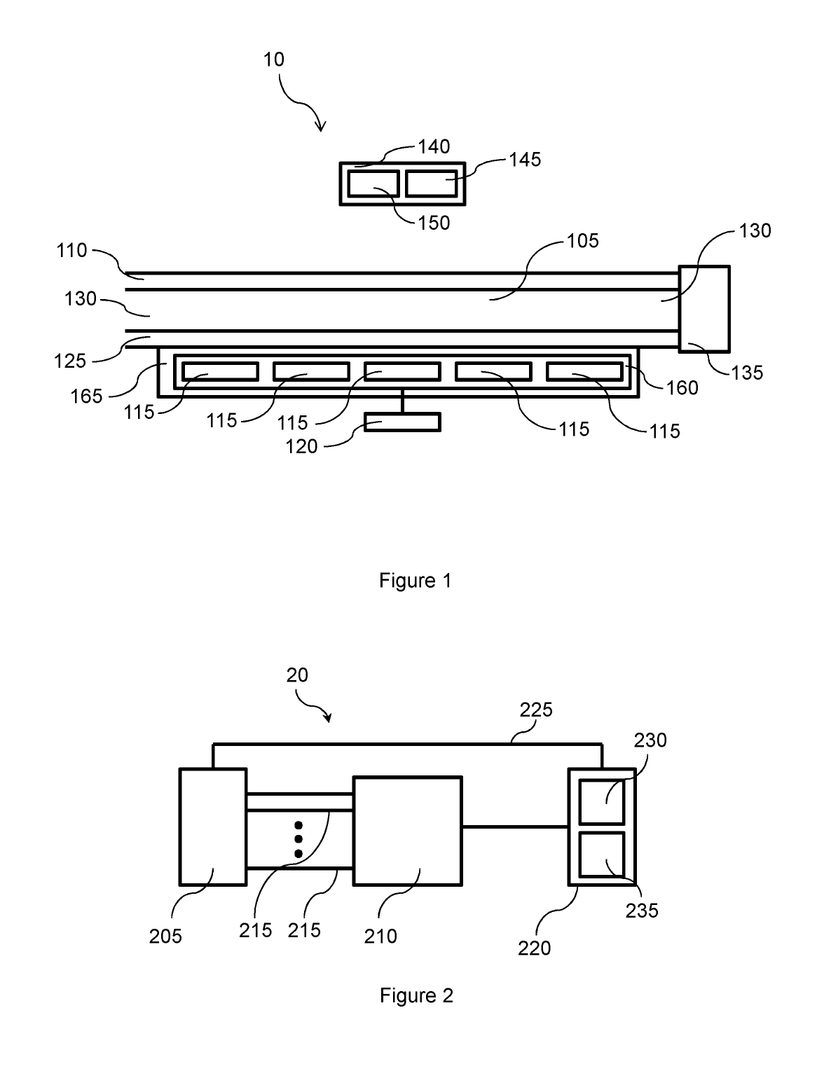

FIG. 1 shows, seen in cross-section, a particular embodiment of the device 10 for handling an element that is the subject of the present invention. This device 10 comprises:
a cavity 105, configured to receive at least one element of a fluid, which comprises:
   a portion 110 of the deformable material deformed by thermomechanical effect;
   a portion 125 made of an electrically insulating material;
   a translucent portion 110;
   two openings 130; and
   a means 135 for generating a flow of a carrier fluid passing by the two openings 130;
a means 120 for ordering at least one local heating means 115;
a thermal rail 160 comprising a plurality of local heating means 115;
in some variants, a means 140 for detecting the position of at least one element in the cavity 105, which comprises:
   an image capture means 145; and
   a means 150 for processing captured images configured to determine the position of an element according to the image processed; and
a substrate 165, comprising the thermal rail 160, secured to the cavity 105.

The cavity 105 is, for example, a duct with a rectangular cross-section, along a transverse axis of the cavity 105, positioned on the substrate 165. This cavity 105 can also have a cross-section of any other geometric shape. This duct comprises a portion 125 made of an electrically insulating material, in contact with the substrate 165. This portion 125 is made of an electrically insulating material such as, for example, PDMS. This portion 125 is thin compared to the thickness of portion 110. The duct comprises a portion 110 made of a deformable material such as, for example, PDMS. The thickness of this portion 110 made of a deformable material is, for example, ten times greater than a dimension of the cross-section of the cavity 105 along a transverse axis of the cavity 105. This duct is, for example, configured to receive elements with a diameter of 80 micrometers. This duct has, for example, a diameter of 100 micrometers. The duct also comprises a translucent portion 110 matching the deformable portion 110. In some variants, the cavity 105 does not comprise a translucent portion. This duct also comprises two openings 130 located at the two ends of the duct. These openings 130 make it possible to inject or eject an element in the duct. In particular, one of these openings 130 can be associated to a means 135 for generating a flow passing by the two openings 130.

In some variants, one of these openings consists of pores in portion 125 or in portion 110 made of a deformable material.

In some variants, portion 125 is made of a non-deformable material.

In some variants, the device 10 comprises a single opening 130 allowing an element to enter the cavity 105.

The means 135 for generating a flow of a carrier fluid is, for example, a syringe-driver or a pressure controller making it possible to inject a fluid into an opening 130 such that the injected fluid exits by another opening 130 of the duct. In some variants, this generating means 135 is configured to inject a multiphase fluid containing at least one fluid element to be handled. This flow of a carrier fluid makes it possible to move at least one element. In some variants, the device 10 does not comprise a flow generating means 135.

The means 120 for ordering at least one local heating means 115 is, for example, a controller connected to each local heating means 115 of the device 10. This ordering means 120 is configured to emit a local heating order separately to at least one local heating means 115 so as to handle an element in the cavity 105. The ordering means 120 is configured to cause the successive heating of at least two adjacent local heating means 115 of the thermal rail 160 so as to move the element along the cavity 105. In effect, the deformation of a portion 110 of the deformable material of the cavity 105 generated by the heating of a first local heating means 115 causes the movement of the element in the cavity 105. If a second local heating means 115 is heated at the new location of the element, a new movement of the element is achieved. Each local heating means 115 positioned along the cavity 105 can be heated so as to move an element from one end to the other of the path formed by the local heating means 115 along the cavity 105. In some variants, the ordering means 120 is ordered by the detection means 140. In these variants, when the device 10 does not comprise a flow generating means 135, the detection means 140 orders the ordering means 120 to successively heat local heating means 115 adjacent to an element according to the detected position of this element.

The ordering means 120 is also configured to order the heating of two local heating means 115 adjacent to the detected position of the element so as to retain the element in a duct. When the device comprises a flow generating means 135, the ordering means 120 can be configured to order the heating of a local heating means 115 adjacent to the detected position of the element so as to retain the element against the deformed portion 110 of the deformable material. This embodiment is shown more specifically in FIG. 5.

The ordering means 120 is, lastly, configured to order the heating of a means 115 where an element is positioned between the means 115 and a deformed portion 110 of the cavity 105 so as to split the element into at least two elements with dimensions smaller than the element split.

Each local heating means 115 is incorporated into a thermal rail 160 ordered by the ordering means 120 and incorporated into the substrate 165. This thermal rail 160 is positioned along the cavity 105 so that each local heating means 115 of the thermal rail 160 is opposite a deformed portion of the deformable material 110 of the cavity 105. The presence of a lubricating film of the second fluid between the element and a portion 125 ensures that there is no element/substrate cross-contamination. Each local heating means 115 is configured to cause, during heating, deformation by thermomechanical effect of a portion of the deformable material 110, of the cavity 105. This deformation causes an obstruction, at least partial, of the cavity 105 blocking the passage of an element at the location of the obstruction. Each local heating means 115 opposite a portion made of a deformable material 110 has a much smaller dimension, of at least one order of magnitude, than the total length of the cavity 105. This dimensional difference means that the cavity 105 can be deformed locally without causing deformation in the entire cavity 105, and thus enables precise control of the handling of an element. The power necessary to deform a portion made of a deformable material 110 is, for example, of the order of 150 mW and the voltage at the terminals of each means is less than 10 V.

Variants of the local heating means are described in FIG. 11, below.

This local heating means heats the cavity 105 over a surface whose largest dimension is of a similar size to the largest dimension of a fluid element crossing the cavity. This local heating enables local fine handling of drops in an otherwise much larger cavity.

The relationship between the dimensions of the deformed portion, the element and the cavity are illustrated in FIG. 13.

This FIG. 13 shows a cavity 1300 having a wall made of a deformable material 1310, an element 1305 of the first fluid being introduced into the cavity 1300.

It shows, in particular, that the largest dimension L2 of the deformed portion 1310 is one order of magnitude smaller than the largest dimension L1 of the cavity 1300. Preferably the deformed portion 1310 is two orders of magnitude smaller than the largest dimension L1 of the cavity 1300.

The dimension L2 of the portion made of a deformable material 1310 is chosen such that, during the deformation of this portion of the deformable material 1310, the smallest dimension L4 of the cross-section of the deformed cavity 1300 does not permit the element 1305 to pass, but does permit the second fluid to flow. This dimension L4 is less than the smallest dimension L5 of the element 1305, the largest dimension of the drop being greater than the dimension L3 of the cavity.

For example, the cross-section of the cavity 1300 is rectangular, the element 1305 having a disk shape and the portion made of a deformable material 1310 having a dimension L2 of the portion of the deformable material that is similar to the cross-section of the element 1305 and therefore of the cavity 1300.

For example, an obstruction formed in the cross-section of the cavity by a portion of the deformable material measures two micrometers.

The element detection means 140, shown in FIG. 1, is, for example, an assembly comprising the image capture means 145 and the means 150 for processing captured images. The image capture means 145 is, for example, a camera positioned so as to be able to capture an image of each translucent portion 110 of the device 10. The image processing means 150 is, for example, an electronic circuit controlled by a computer program configured to establish, by detecting shapes, the presence or not of an element in an area of the cavity 105 according to the captured image. This detection means 140 is configured to transmit a position signal to the ordering means 120. This position signal is used by the ordering means 120 to determine which local heating means 115 must be heated. In some variants, this detection means 140 is an electronic circuit, connected to a coil surrounding the cavity at least partially, configured to detect an element of the first fluid according to a disturbance in an electromagnetic field near the cavity 105.

The substrate 165 comprising the thermal rail 160, secured to the cavity 105, can be separated from the portion 125, which makes it possible to recycle the thermal rail 160 that the substrate 165 comprises.

FIG. 2 shows, schematically, a particular embodiment of the device 20 that is the subject of the present invention. This device 20 comprises an ordering means 205 which sends an order signal separately, via a separate order channel 215, to each local heating means 210 of the device 20. The detection means 220, comprising for example a position detection system 230 and a system for detecting the content 235 of elements in the device 20, is connected to the ordering means 205 via another order channel 225.

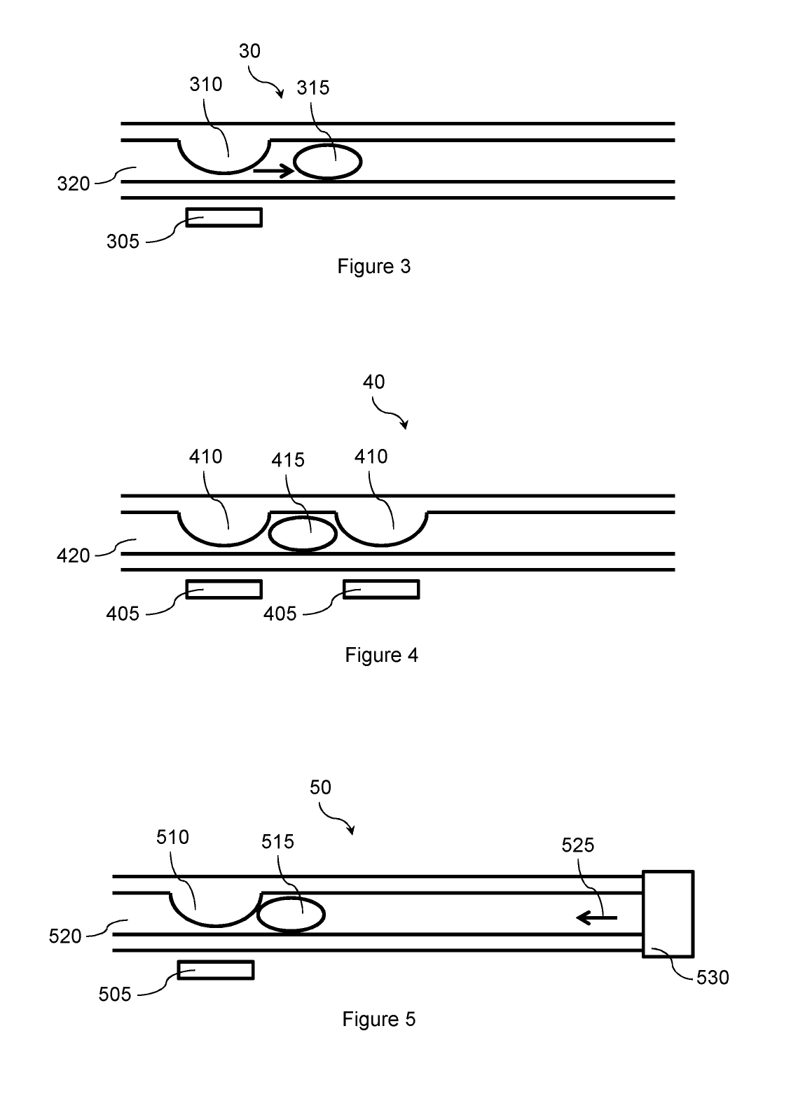

FIG. 3 shows, seen in cross-section, a particular embodiment of the device 30 for moving an element 315 by the device 10 that is the subject of the present invention. In this embodiment, the device 10 does not comprise a flow generating means. The movement of an element 315 is realized when an element 315 is present in a cavity 320 opposite the deformable material 310 of the cavity 320. If an order to move the element 315 is received by an ordering means, not shown, of the local heating means 305, this ordering means orders the heating of the local heating means 305. This local heating means 305 causes the expansion of the portion made of a deformable material 310 in the cavity 320. When the portion made of a deformable material 310 presses on the element 315, the element 315 is pushed in the cavity 320 so as to produce a longitudinal movement. In some variants, a plurality of means is utilized so as to cause a step-by-step movement of the element 315. These embodiments enable at least one element to be moved with no flow of the second fluid.

FIG. 4 shows, seen in cross-section, a particular embodiment of the device 40 for isolating an element 415 by the device 10 that is the subject of the present invention. This isolation of element 415 is achieved by simultaneously heating two heating means 405 positioned opposite the deformable material, causing deformations 410 adjacent to the position of an element 415 located in a cavity 420. The element 415 therefore finds itself trapped between two deformable portions 410 deformed by thermomechanical effect. In some variants, the element 415 is positioned between two non-adjacent deformable portions of the cavity 410, deformed by the action of two local heating means 405.

FIG. 5 shows, seen in cross-section, a particular embodiment of the device 50 of a capillary valve by the device 10 that is the subject of the present invention. This capillary valve is produced when a deformed portion 510 of the deformable material of a cavity 520 is deformed by thermomechanical effect by the activation of a local heating means 505 while an element 515 is pushed towards the deformation by a flow 525 of a fluid, for example. This flow 525 is generated by a means 530 for generating a flow of the second fluid. This valve is open when the local heating means 505 is not heating, and therefore when the portion made of a deformable material 510 does not obstruct the passage of the element 515. Conversely, the valve is closed when the means 505 is heating and the deformed portion of the deformable material prevents the passage of an element 515 in the cavity 520.

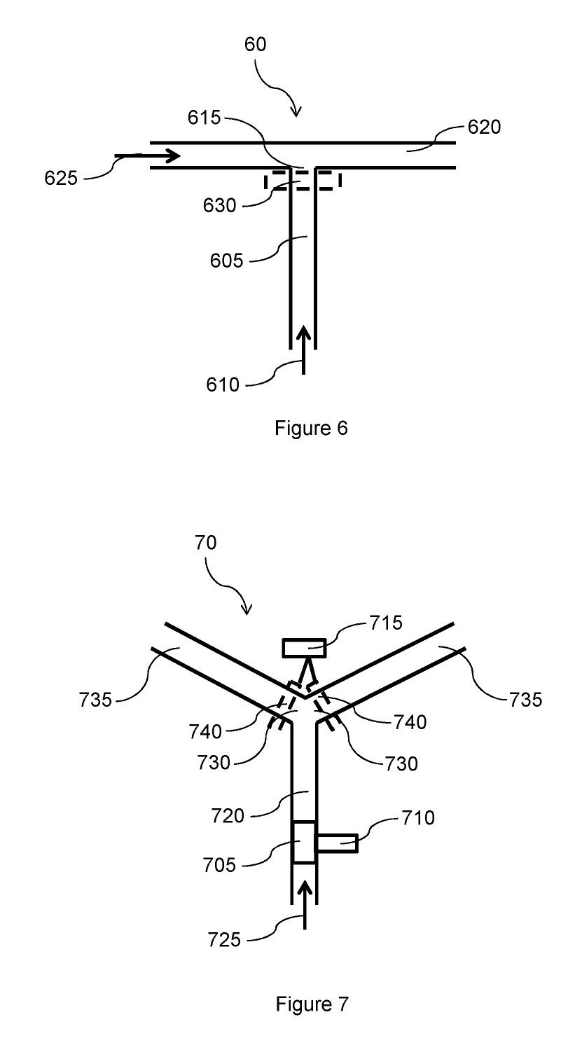

FIG. 6 shows, seen from above, a particular embodiment of the device 60 for generating an element that is the subject of the present invention. This device 60 comprises:
a cavity 605, crossed by a longitudinal flow 610 of a first fluid, which will be dispersed in a secondary cavity 620, which comprises a junction 615, located downstream from the flow 610, entering the secondary cavity 620 crossed by a flow 625 of a second fluid; and
a local heating means positioned opposite the deformable material at the intersection 615 of the two cavities, 605 and 620, so as to block the passage of the first fluid from the cavity 605 towards the secondary cavity 620, thus blocking the formation of elements.

The cavity 605 is, for example, similar to the cavity 105 described in FIG. 1. This cavity 605 is crossed by a flow 610 of a first fluid that is immiscible with the second fluid carried by the flow 625.

To generate an element, not shown, of the first fluid, the local heating means is heated so as to block the passage of an element injected by the flow 610. When an element generation order is received by the device 60, the local heating means stops heating so as to allow the first fluid to enter the secondary cavity 620. After a predefined length of time, the local heating means is heated again so as to split the element passing between the local heating means and a portion made of a deformable material 630 of the cavity 605. The portion of the first fluid having crossed the means in this way is thus injected into the cavity 620 and generates an element of the first fluid that can be used according to various requirements.

Without the action of a local heating means, an element can form naturally but its size is then determined by the ratios of the rates of flows 610 and 625, and by the geometry of the junction 615 between the two cavities, 605 and 620. Thanks to the embodiment of the device 60 described in FIG. 6, the size of the elements generated can be controlled. There are therefore two possible variants when the local heating means is deactivated:
either the element is left to form freely and the local heating means is activated to block the formation of a new element; or
the local heating means is activated after a predefined length of time to generate elements of a controlled size.

In some variants, the junction 615 connects upstream a plurality of cavities 605 and a plurality of flows 625, emerging downstream into at least one single cavity 620.

In other variants, a plurality of cavities 605 in which each cavity 605 transports an element of at least a secondary fluid transported in the first fluid. At least two secondary fluids are miscible with each other. In this way, the elements generated and moved into at least one single cavity 620 from at least two cavities 605 can mix so as to become an “element of a second fluid” as described in the description of the figures. Thus, the generating device 60 can comprise a plurality of cavities 605 transporting a fluid allowing an element to be generated, and a plurality of cavities 620 transporting a generated element.

FIG. 7 shows, seen from above, a particular embodiment of the device 70 for sorting an element that is the subject of the present invention. This device 70 comprises:
a means 705 for identifying the nature of an element;
a means 710 for activating an ordering means 715 of a device 10 as described in FIG. 1;
the device 10 for handling an element, in which:
   the cavity 720 is crossed by a longitudinal flow 725 comprising elements of a first fluid dispersed in the second fluid;
   two openings 730 of the cavity 720, located downstream from the flow 725, each of which enters into a secondary cavity 735; and
   a local heating means is positioned opposite the deformable material 740 at each intersection so as to block the passage of an element from the cavity 720 to a secondary cavity 735.

The means 705 for identifying an element is, for example, a coil surrounding an area of the cavity 720 configured to measure the impedance of the fluid of the element and to determine the nature of the fluid according to the impedance measured.

In some preferential variants, the device 70 does not comprise an identification means 705.

The activation means 710 is, for example, an electronic circuit configured to order the ordering means 715 to heat the local heating means positioned at the opening 730 of the secondary cavity 735, into which one does not want the identified fluid element to enter. Conversely, the ordering means 715 orders the heating of the local heating means positioned at the opening 730 of the secondary cavity 735, into which one wants the identified fluid element to enter, to stop if this local heating means is in the process of heating. In this way, it is possible to sort elements entering into the device 70 by selectively opening a secondary cavity 735 into which the element is directed.

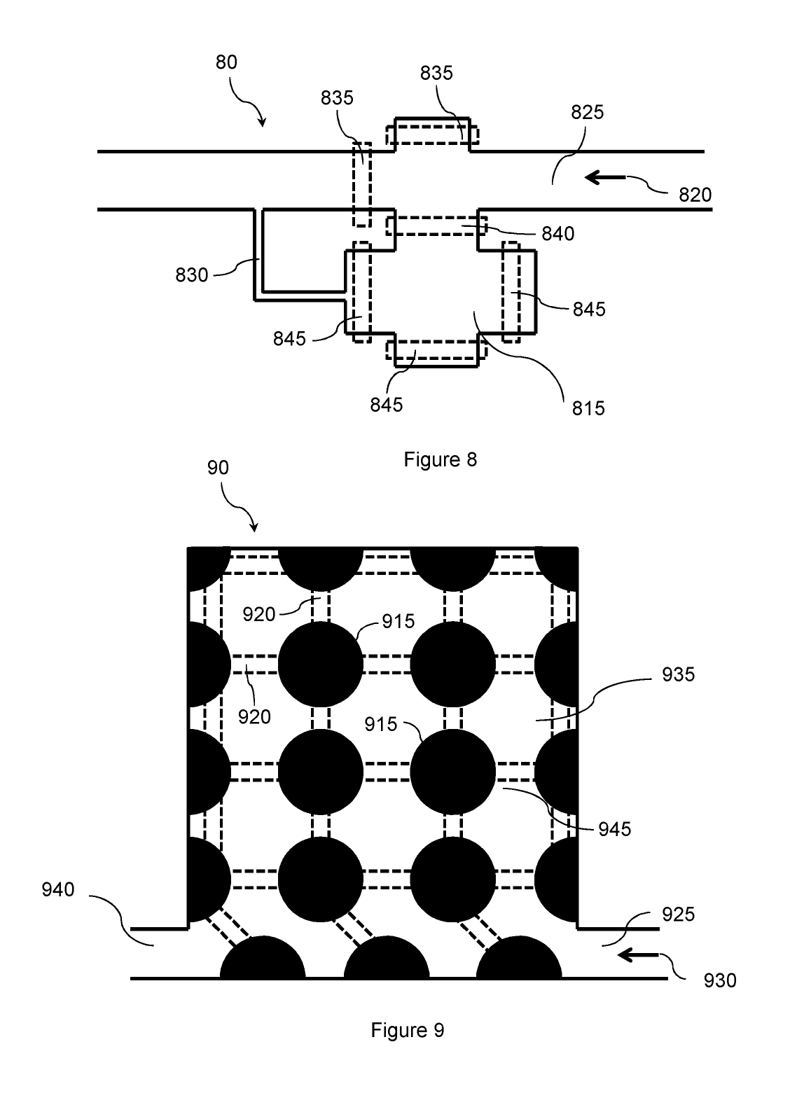

FIG. 8 shows, seen from above, a particular embodiment of the device 80 for storing/restituting an element of an immiscible first fluid. This device 80 comprises a main cavity 825 crossed by a flow 820 of dispersed elements of the first fluid. This device 80 also comprises a secondary cavity 815 towards which the elements can be directed and therefore stored. The ordering means makes it possible to activate local heating means heating deformable portions 835 during the passage of at least one element detected by the detection means, directing the elements into the secondary cavity 815 allowing storage. A bypass cavity 830 allows the free circulation of a second fluid transporting the elements of the first fluid. In some variants, the device 80 does not comprise a bypass cavity 830. In some variants, the cavity 815 is isolated from the secondary cavity 825 by activating a local heating means, heating a portion of the deformable material 840 of the cavity, ordered by the ordering means. In the restitution phase:
a local heating means, configured to heat a portion of the deformable material 835 of the main cavity 825 so as to block the passage of an element in this cavity 825, is deactivated, and
local heating means, heating deformable portions 845, are activated by the ordering means so as to propel at least one element from the secondary cavity 815 towards the main cavity 825.

In the variants comprising a local heating means 840, the restitution phase is performed by the following sequence:
the local heating means, heating the portion of the deformable material 840, isolating the secondary cavity 815, is deactivated;
the local heating means, configured to heat a portion of the deformable material 835 of the main cavity 825 so as to block the passage of an element in this cavity 825, is deactivated and
the local heating means, heating the deformable portions of the cavity 845, are activated by the ordering means so as to propel at least one element from the secondary cavity 815 towards the main cavity 825; and
the cavity 815 is isolated by activating the local heating means heating the deformed portion of the deformable material 840.

In some variants, the deformed portion of the deformable material opposite the local heating means, heating the portion made of a deformable material 840 located at the junction between the primary cavity and the secondary cavity, is configured to be heated when an element is stored in the structure.

Another embodiment of the storage/restitution device 80 makes it possible to reorganize a sequence of immiscible fluid elements. In these embodiments, the device 80 comprises at least one secondary cavity in which elements are stored. In some variants, the storage is performed according to their nature detected by a detection means. According to an elements sequence order received by a means for ordering the heating of local heating means, the restitution of at least one element is caused sequentially in at least one secondary cavity. In this way, a sequence of elements can be reorganized by first of all storing each element separately and then selectively restituting the stored elements according to their nature.

FIG. 9 shows, seen from above, a particular embodiment of the device 90 that is the subject of the present invention. In this figure, a cavity 945 of the device 90 extends along two axes. This cavity 945 is formed of compartments 935 delimited by four links between studs 915 distributed in the cavity 945, positioned so as to form four corners of a square.

In some variants, compartments of any polygonal geometry whatsoever comprising at least three sides are used.

In some variants, these compartments are delimited by deformed portions, whose function is similar to that of the studs described above, of the cavity causing a deformation of the cavity.

The accumulation of compartments makes it possible to create a two-dimensional matrix allowing a plurality of functions to be performed. A deformed portion of the deformable material 920 is positioned opposite each edge of the square thus delimited. It is possible, during the heating of at least one portion of the deformable material 920, to:
block the access to a compartment when each deformed portion of the deformable material 920 is heated by a local heating means;
create a unidirectional cavity when two opposite deformed portions 920 are heated simultaneously;
create a bend for a unidirectional cavity connected to the compartment when two adjacent deformed portions 920 are heated simultaneously;
propel an element towards an adjacent cavity located opposite a portion of the deformable material 920.

This device 90 also comprises a cavity 925 serving as an inlet for elements of an immiscible first fluid transported by a flow 930 of a second fluid. This device 90 comprises an outlet cavity 940 positioned opposite the inlet cavity 925 such that the flow 930 of the second fluid is directed towards the outlet cavity 940. Deformed portions 920 are positioned on the path of the flow 930 between the inlet cavity 925 and the outlet cavity 940. In this way, when the local heating means is heating, an element pushed by the flow 930 is directed towards a compartment of the matrix by the deformation of a portion of the deformable material 920. Inside the two-dimensional cavity 935, it is possible to perform all of the functions detailed in FIGS. 1 to 8, namely, for example:
capillary valve;
generating an element;
splitting an element;
isolating an element;
sorting an element;
combining at least two elements;
moving an element; and
reorganizing a sequence of elements.

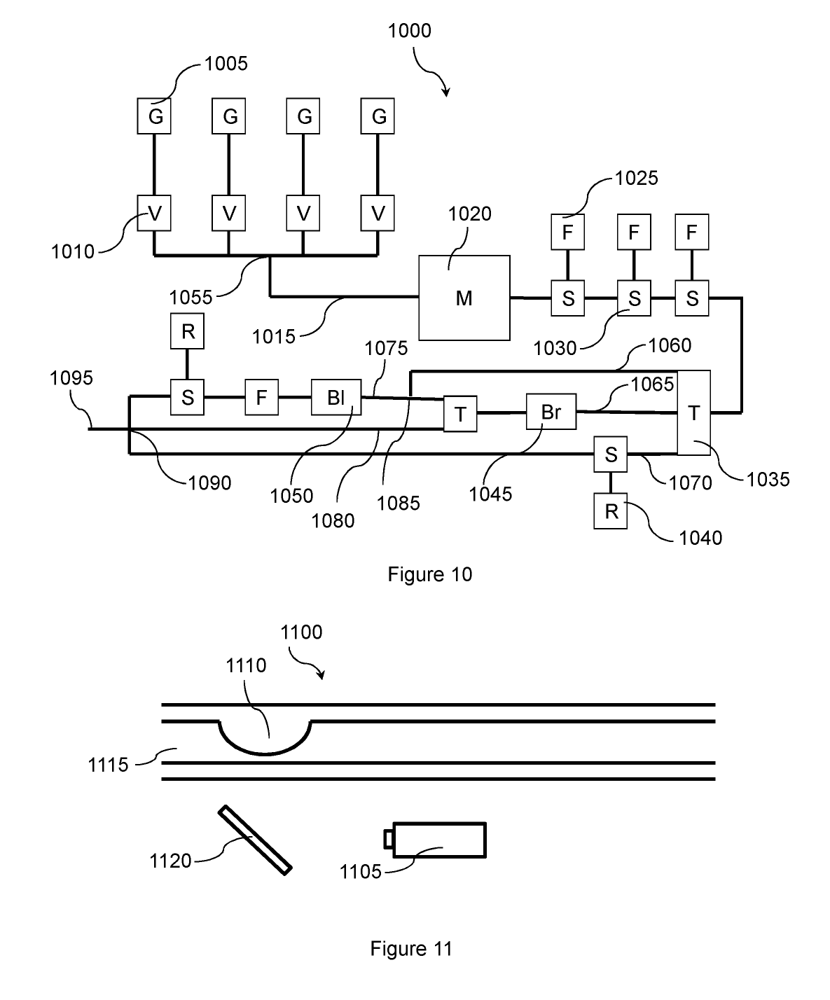

FIG. 10 shows, schematically, a particular embodiment of a network 1000 for handling immiscible fluid elements. This network comprises four generators of elements 1005 as described in FIG. 6 producing, from one generator to the next, elements whose composition and volumes can be different. These elements are routed in a cavity 1010 comprising a capillary valve system as described in FIG. 5. These capillary valves make it possible, in this embodiment, to predefine the number of elements of each nature for a given sequence of elements at the junction 1055.

Each sequence of elements is routed, via a channel 1015, in a cavity 1020 comprising a two-dimensional matrix system as described in FIG. 9. In one embodiment, the order of elements of the sequence entering into the matrix can be modified on output.

One or more elements of the sequence can be stored in one or more storage cavities 1030 via the device described in FIG. 8 so as, possibly, to make them combine, in a combining device 1025. This operation makes it possible to generate larger elements containing various elements from successive sequences. The advantage of combining elements is to perform high-throughput screening, ie to test a large number of possible combinations of elements.

These elements can be expelled from the cavity 1030 via the restitution system as described in FIG. 8. These elements are then routed towards a sorting device 1035 as described in FIG. 7, comprising a detection means and three outlet branches 1060, 1065 and 1070.

The elements routed in the branch 1060 are routed directly to a junction 1085. The elements routed to a junction 1065 are split into at least two smaller elements in the cavity 1045 comprising a device for splitting elements.

The elements coming from the splitting are routed to a sorting device 1035 as described in FIG. 7, comprising a detection means and two outlet branches 1075 and 1080. The elements routed by the branch 1080 are routed directly to a junction 1090.

The elements routed by the branch 1075 are blocked by a device 1050 as described in FIG. 5 so as to be put into contact with the elements coming from the branch 1060 via the junction 1085. The elements thus put into contact can be freed by the device 1050, then combined via another combining device 1025.

The element resulting from the combination is routed in a cavity comprising a thermal rail 1040, via a storage device 1030 as described in FIG. 8. In the thermal rail, as described in FIG. 1, the element is routed to any position whatsoever of the rail. The position chosen makes it possible, for example, to observe a change in the nature of the element as a function of time. If the element is not stored, this element is routed directly towards a junction 1090.

The elements routed in the branch 1070 are transported towards a cavity comprising a thermal rail 1040, via a storage device 1030 as described in FIG. 8. In the thermal rail, as described in FIG. 1, the element is routed to any position whatsoever of the rail. If the element is not stored, this element is routed directly towards the junction 1090. All the elements arriving at the junction 1090 are evacuated via an outlet 1095.

FIG. 11 shows a particular embodiment of the device 1100 that is the subject of the present invention. This device 1100 is similar to the device 10 described in FIG. 1. In this device 1100, the local heating means is an assembly comprising a laser 1105 and a mirror 1120, the mirror 1120 being configured to orient the beam of the laser 1105 towards a portion made of a deformable material 1110 of the cavity 1115 according to a local heating order emitted by the ordering means, not shown. In some variants, the device 1100 does not comprise a mirror 1120 and the laser 1105 comprises a matrix shutter configured to allow the passage of the beam of the laser 1105 according to a local heating order emitted by the ordering means. In other variants, the laser 1105 is mounted on a pivoting device allowing the beam of the laser 1105 to be oriented according to a local heating order emitted by the ordering means. In other variants, the local heating means utilizes any know means for emitting an electromagnetic wave so as to produce the heating of the portion made of a deformable material 1110. In some variants, other techniques of local heating can be employed such as, for example, devices using the Joule effect, preheated fluids, micro-waves, an infra-red signal. The differences between these techniques lie in the transition time for establishing the temperature and for integration.

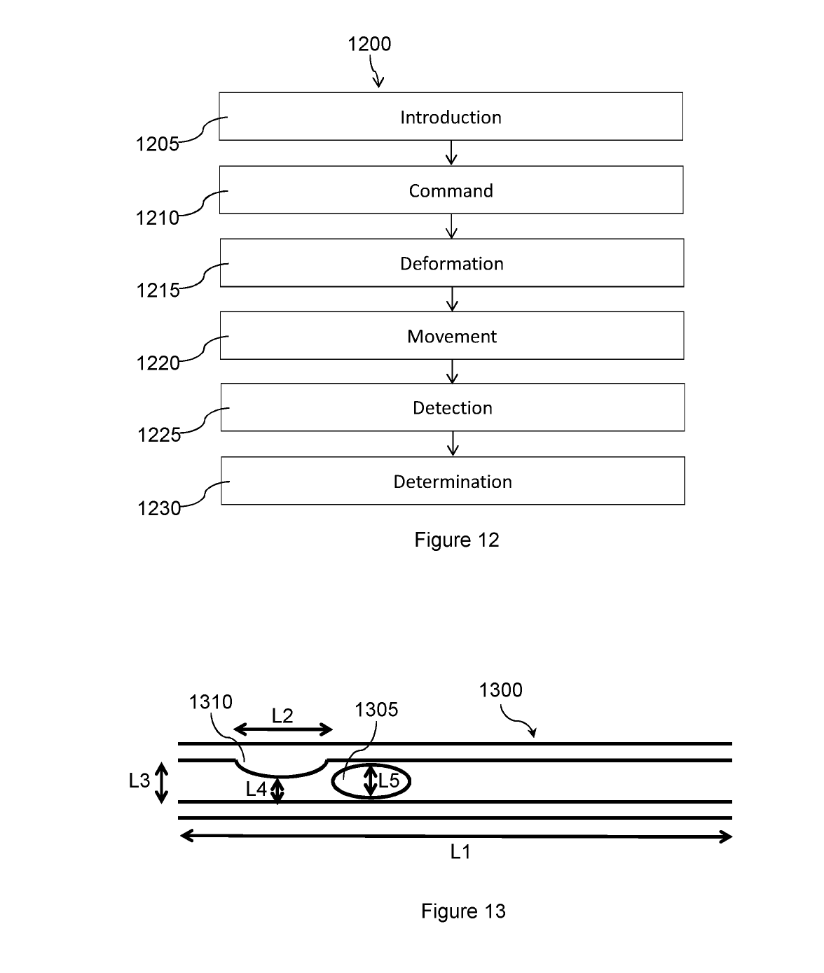

FIG. 12 shows a logical diagram of particular steps of the process 1200 that is the subject of the present invention. This process 1200 for handling an element consisting of a first fluid transported in a second fluid, immiscible with the first fluid, in a cavity, at least one wall of which is made of a deformable material, comprises:
a step 1205 of introducing the second fluid and the element of the first fluid into the cavity;
a step 1210 of ordering a local deformation of a portion of the deformable material of the cavity, at least one other portion made of a deformable material of the cavity not being deformed;
a step 1215 of locally deforming a portion of the deformable material of the cavity in order to at least partially obstruct the passage of the element introduced into the cavity without obstructing the passage of the second fluid; and
a step 1220 of moving the element in the cavity to the outside of the deformed portion of the cavity.

The introduction step 1205 is performed, for example, by utilizing a supply of elements of the first fluid transported by the second fluid. This supply pushes these elements into the cavity.

The ordering step 1210 is performed, for example, by an ordering means as described with regard to one of FIGS. 1 to 11.

The local deformation step 1215 is performed, for example, by:
locally heating a portion of the deformable material, the portion made of a deformable material being deformed by thermomechanical effect;
a pneumatic deformation means; and/or
a piezoelectric deformation means.

The local heating is similar to the heating described with regard to one of FIGS. 1 to 11 above.

The pneumatic deformation means is, for example, a duct contained in the wall of the cavity, the pressure of a fluid inside this duct being increased such that the duct enlarges and partially obstructs the cavity.

The piezoelectric deformation means is a piezoelectric material where the application of an electrical current on this material causes a deformation partially obstructing the cavity.

The moving step 1220 depends on the type of handling performed, the various types of handling being described with regard to FIGS. 1 to 11.

In some particular embodiments, the process 1200 comprises a step 1230 of determining the position of an element of the cavity according to the position of a deformed portion of the cavity.

This determination step 1230 is performed, for example, during the utilization of a thermal rail as described above, according to the thermal element of the rail activated making it possible to predict the position of the element in the cavity.

In some particular embodiments, the process 1200 comprises a step 1225 of detecting the position of an element in the cavity, the ordering step 1210 ordering the deformation of a portion of the deformable material of the cavity selected according to the detected position of the element.

This detection step 1225 is performed, for example, by an optical, inductive, capacitive or resistive sensor positioned opposite the portion of the cavity and configured to detect the passage of an element.

1-24. (canceled)

25. A process for handling an element consisting of a first fluid transported by a second fluid that is immiscible with the first fluid in a cavity, at least one wall of the cavity is made of a deformable material, comprising the steps of:
introducing the second fluid and the element of the first fluid into the cavity;
ordering a local deformation of the deformable material of the cavity, at least one other portion of the deformable material of the cavity not being deformed;
locally deforming a portion of the deformable material forming the cavity to at least partially obstruct a passage of the element introduced into the cavity without obstructing a passage of the second fluid; and
moving the element in the cavity to outside of the deformed portion of the cavity.

26. The process according to claim 25, further comprising the step of determining a position of the element in the cavity in accordance with a position of the deformed portion of the cavity.

27. The process according to claim 25, further comprising the step of detecting a position of the element in the cavity; and wherein the ordering step orders the local deformation of the portion of the deformable material of the cavity selected in accordance with the detected position of the element.

28. The process according to claim 25, wherein the local deformation of the portion of the deformable material is performed by locally heating the deformable material, the deformed portion of the deformable material being deformed by thermo-mechanical effect.

29. A device implementing the process according to claim 25 to handle the element consisting of the first fluid transported in the second fluid that is immiscible with the first fluid, comprising:
the cavity configured to receive at least one element consisting of the first fluid and the second fluid and comprising said at least one wall made of the deformable material;
at least one local heater configured to deform at least one portion of the deformable material of the cavity by a thermo-mechanical effect such that each portion of the deformable material heated obstructs at least partially a section of the cavity to allow the passage of the second fluid and to block the passage of each element of the first fluid, at least one other portion of the deformable material of the cavity not being deformed;
a flow generator to move said at least one element consisting of the first fluid to outside of a deformed portion of the deformable material; and
a controller configured to separately control said at least one local heating.

30. The device according to claim 29, wherein the flow generator is a thermal rail, the thermal rail comprises at least one local heater configured to deform at least one portion of the deformable material of the cavity by thermo-mechanical such that said each deformed portion of the deformable material heated obstructs at least partially a section of the cavity to allow the passage of the second fluid and to block the passage of said each element of the first fluid.

31. The device according to claim 29, wherein the cavity comprises at least one side portion made of a material that is not deformable by the heat emitted by said at least one local heater.

32. The device according to claim 29, further comprising a detector to content of said at least one element of the first fluid.

33. The device according to claim 29, further comprising a detector to detect a position of said at least one element in the cavity and to supply a position signal to the controller.

34. The device according to claim 33, wherein the cavity comprises at least one translucent portion; and wherein the detector comprises an image capturing device and a processor to process captured images and determine the position of said at least one element in accordance with the processed images.

35. The device according to claim 34, wherein the detector is configured to detect said at least one element of the first fluid in accordance with a disturbance in an electromagnetic field near the cavity.

36. The device according to claim 29, wherein the controller is configured to instruct said at least one local heater to heat at least two portions of the deformable material adjacent to the detected position of said at least one element to isolate said at least one element in a portion of the cavity obstructed at each end by a deformation of the cavity.

37. The device according to claim 29, wherein the controller is configured to instruct said at least one local heater to heat a portion of the deformable material of the cavity at the detected position of said at least one element to split said at least one element into two elements positioned towards outside of the heated portion of the deformable material.

38. The device according to claim 29, further comprising a substrate secured to the cavity, the substrate comprising at least one local heater.

39. A device for generating elements consisting of the first fluid transported in the second fluid that is immiscible with the first fluid, comprising:
the device for handling an element according to claim 29;
an opening of at least one cavity towards a secondary cavity is crossed by at least one continuous phase flow;
the flow generator is configured to move a flow of the first fluid in said at least one cavity towards the secondary cavity to form the element of the first fluid in the secondary cavity; and
said at least one local heater heats the deformable material positioned at an intersection of the two cavities such that the passage of the elements from said at least one cavity to the secondary cavity is blocked or forced.

40. The device for sorting at least one element consisting of a first fluid transported in a second fluid that is immiscible with the first fluid, comprising:
the handling device according to claim 29, the handling device further comprising at least two openings of the cavity located downstream of a direction of a movement of the flow generator, each opening is directed towards a secondary cavity;
an activator to activate the controller of the handling device;
wherein said at least one local heater heats the deformable material positioned at each intersection of the two cavities to block the passage of the element from said at least one cavity to at least one secondary cavity.

41. The device for storing/restituting the element consisting of the first fluid transported in the second fluid that is immiscible with the first fluid, comprising:
the handling device according to claim 29, wherein one portion of the deformable material is configured, during the deformation, to block the passage of the element in a primary cavity and direct the element towards a storage/restitution structure; and
wherein the storage/restitution structure is configured to restitute the element during heating of a portion of the deformable material of the storage/restitution structure by a local heater of a secondary device.

42. The device according to claim 41, further comprising a deformed portion of the deformable material located at a junction between the primary cavity and the storage/restitution structure.

43. A device for combining two elements consisting of first miscible fluids transported in the second fluid immiscible with each first fluid, comprising the handling device according to claim 29 and a plurality of deformed portions configured to force the two elements into contact by successively moving at least one of the two elements.

44. A matrix device for handling an element consisting of the first fluid transported in the second fluid that is immiscible with the first fluid, comprising the handling device according to claim 29; and wherein the cavity extends in two directions and comprises at least one compartment comprising at least three outlets and at least one deformed portion of the deformable material positioned opposite at least one outlet.
